(19) United States
(12) Patent Application Publication
(10) Pub. No.: US 2021/0341664 A1
(43) Pub. Date: Nov. 4, 2021

(54) BACKLIGHT MODULE AND DISPLAY DEVICE

(71) Applicant: WUHAN CHINA STAR OPTOELECTRONICS TECHNOLOGY CO., LTD., Wuhan (CN)

(72) Inventor: Shiyuan Xiao, Wuhan (CN)

(73) Assignee: WUHAN CHINA STAR OPTOELECTRONICS TECHNOLOGY CO., LTD., Wuhan (CN)

(21) Appl. No.: 16/619,983

(22) PCT Filed: Jun. 5, 2019
(86) PCT No.: PCT/CN2019/090118

§ 371 Date: Dec. 6, 2019

(30) Foreign Application Priority Data
May 22, 2019 (CN) 201910430262.4

(51) Int. Cl. F21V 8/00

(52) U.S. Cl. CPC G02B 6/0066; G02B 6/0055; G02B 6/0088

(57) ABSTRACT

A backlight module and a display device are disclosed. The backlight module includes a light guide plate, a light source, and a bracket. The bracket includes a backplate and a bending portion disposed along a peripheral side of the backplate. An accommodation groove is formed in a space between the backplate and the bending portion and is configured to place the light guide plate. A first groove is disposed on an inner side of the bending portion facing and exposed to the light guide plate, and the light source is disposed in the first groove.

### BACKGROUND OF INVENTION

### 1. Field of Invention

The present invention relates to a technical field of display panels, and particularly to, a backlight module and a display device.

### 2. Related Art

With development of display panel technology and automotive technology, automotive low temperature poly-silicon (LTPS) display panels are increasingly used in an automotive field due to their narrow bezel characteristics. Therefore, standards for on-board LTPS display devices are also raised.

In current technology, light sources of display devices are fixed on inner sides of brackets near light guiding plates, so that a sufficient space is reserved between the brackets and the light guiding plates to place the light sources, resulting in a large distance between the brackets and the light guiding plates, thereby causing an increase in width of frames of the display devices adjacent to the light sources.

### SUMMARY OF INVENTION

The present application provides a backlight module and a display device to overcome the problem that a frame of a conventional display device at a side of a light source is increased in width.

The present application provides a backlight module, comprising a light guide plate, a light source, and a bracket; wherein the bracket comprises a backplate and a bending portion disposed along a peripheral side of the backplate, and an accommodation groove is formed in a space between the backplate and the bending portion and is configured to place the light guide plate; and wherein a first groove is disposed on an inner side of the bending portion facing and exposed to the light guide plate, and the light source is disposed in the first groove

Further, a second groove is disposed on an outer side of the bending portion facing the first groove and exposed outside, wherein the first groove and the second groove communicate with each other.

Further, an adjoining area of where the first groove communicates with the second groove is greater than or equal to a cross-sectional area of the light source in a direction parallel with the bending portion, and the second groove has a bottom area greater than that of the first groove.

In one embodiment, one end of the light source is insertably disposed in the first groove through the second groove, and another end of the light source is detachably connected to a bottom of the second groove.

Further, a first fixing tape is disposed on the bottom of the second groove, wherein the first fixing tape is a single-sided tape; and wherein the first fixing tap has an adhesive surface disposed facing the first groove and adhering to both the bottom of the second groove and the another end of the light source.

In another embodiment, the light source is insertably disposed in the first groove through an opening of the first groove, and one end of the light source is detachably connected to a bottom of the first groove.

Further, a second fixing tap is disposed on the bottom of the first groove, and the second fixing tap is a double-sided tape; and wherein the second fixing tap has two adhesive surfaces adhering to an end surface of the light source and the bottom of the first groove, respectively.

Further, the backlight module further comprises a reflective sheet and an optical film, wherein the reflective sheet, the light guide plate, and the optical film are sequentially disposed on the backplate in the accommodation groove.

An embodiment of the present invention further provides a display device, comprising a display panel and a backlight module, wherein the backlight module comprises a light guide plate, a light source, and a bracket, wherein the bracket comprises a backplate and a bending portion disposed along a peripheral side of the backplate, and an accommodation groove is formed in a space between the backplate and the bending portion and is configured to place the light guide plate; and wherein a first groove is disposed on an inner side of the bending portion facing and exposed to the light guide plate, and the light source is disposed in the first groove, wherein the light guide plate and the display panel are sequentially disposed on the backplate in the accommodation groove.

Further, a second groove is disposed on an outer side of the bending portion facing the first groove and is exposed outside, wherein the first groove and the second groove communicate with each other.

Further, an adjoining area of where the first groove communicates with the second groove is greater than or equal to a cross-sectional area of the light source in a direction parallel with the bending portion, and the second groove has a bottom area greater than that of the first groove.

In one embodiment, one end of the light source is insertably disposed in the first groove through the second groove, and another end of the light source is detachably connected to a bottom of the second groove.

Further, a first fixing tape is disposed on the bottom of the second groove, wherein the first fixing tape is a single-sided tape; and wherein the first fixing tap has an adhesive surface disposed facing the first groove and adhering to both the bottom of the second groove and the another end of the light source.

In another embodiment, the light source is insertably disposed in the first groove through an opening of the first groove, and one end of the light source is detachably connected to a bottom of the first groove.

Further, a second fixing tap is disposed on the bottom of the first groove, and the second fixing tap is a double-sided tape; and wherein the second fixing tap has two adhesive surfaces adhering to an end surface of the light source and the bottom of the first groove, respectively.

Further, the backlight module further comprises a reflective sheet and an optical film, wherein the reflective sheet, the light guide plate, and the optical film are sequentially disposed on the backplate in the accommodation groove.

Further, the display device further comprises a cover plate and a middle frame configure for supporting the display panel; wherein the middle frame is disposed in the accommodation groove and is connected to the inner side of the bending portion; and wherein the light guide plate, the middle frame, and the display panel are sequentially disposed on the backplate in the accommodation groove, and the cover plate is disposed on a side of the bracket far away from the backplate.

The present invention has advantageous effects as follows: the first groove is disposed on the inner side of the bending portion facing and exposed to the light guide plate, and the light source is disposed in the first groove without the need of reserving an extra space at the inner side of the bending portion, thereby to reduce a frame size of the display device at a side of the light source in a condition that a light mixing distance in the backlight module is constant. The second groove is disposed on the outer side of the bending portion exposing outside and communicating with the first groove, wherein an adjoining area of the first and second grooves is greater than or equal to a cross-sectional area of the light source in a direction parallel with the bending portion, so that the light source can be taken out directly from the second groove to be replaced, without disassembling the backlight module, thereby to improve replacement efficiency.

### BRIEF DESCRIPTION OF DRAWINGS

To better illustrate embodiments or technical solutions in the prior art, a brief description of the drawings used in the embodiments or the prior art description will be given below. Obviously, the accompanying drawings in the following description merely show some embodiments of the present invention, and a person skilled in the art may still derive other drawings from these accompanying drawings without creative efforts.

FIG. 1 is a schematic structural view of a backlight module of an embodiment of the present invention.

FIG. 2 is another schematic structural view of a backlight module of an embodiment of the present invention.

FIG. 3 is a schematic structural view of a display device of an embodiment of the present invention.

### DESCRIPTION OF PREFERRED EMBODIMENTS

The preferred embodiments of the present invention are described below with reference to the accompanying drawings, which are used to exemplify the embodiments of the present invention, which can fully describe the technical contents of the present invention to make the technical content of the present invention clearer and easy to understand. However, the invention may be embodied in various forms of embodiments, and the scope of the invention is not limited to the embodiments set forth herein.

The terms used in the description of the present invention are intended to describe an embodiment, and are not intended to illustrate the concept of the invention. Expressions used in the singular form cover plural forms of expression unless the context clearly dictates otherwise. In the description of the present invention, it is to be understood that the terms such as “include”, “have”, and “include” are intended to describe the possibility of one or more other features, numbers, steps, actions, or combinations disclosed in the present invention, and are not intended to exclude the possibility that one or more other features, numbers, steps, acts, or combinations thereof may be added. The same reference numerals in the drawings denote the same parts.

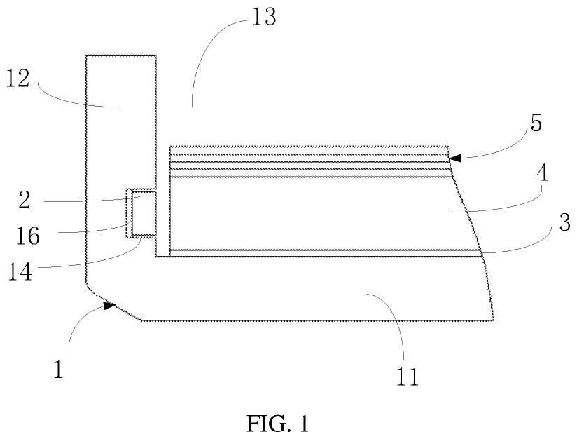

Please refer to FIG. 1. FIG. 1 is a schematic structural view of a backlight module of an embodiment of the present invention. As shown in FIG. 1, the backlight module of the embodiment includes a bracket 1, a light source 2, a light guide plate 4. The bracket 1 includes a backplate 11 and a bending portion 12 disposed along a peripheral side of the backplate 11, and an accommodation groove 13 is formed in a space between the backplate 11 and the bending portion 12, wherein the bending portion 12 is perpendicularly connected to peripheral sides of the backplate 11. The backplate 11 is formed as a bottom of the accommodation groove 13, and the bending portion 12 is formed as a groove wall of the accommodation groove 13. The accommodation groove 13 is configured to place the light guide plate 4 and other components, so that the light guide plate 4 and the other components can be protected by the bracket 1.

A first groove 14 is disposed on an inner side of the bending portion 12 facing and exposed to the light guide plate 4, wherein the inner side of the bending portion 12 is a surface of the bending portion 12 adjacent to a side of the accommodation groove 13. The first groove 14 forms an opening facing the accommodation groove 13 to allow the first groove 14 to communicate with the accommodation groove 13. The light source 2 is disposed in the first groove 14, and has a light emitting surface disposed adjacent to the accommodation groove 13, so that light emitted from the light source 2 can enter the accommodation groove 13. The light source 2 may be a light emitting diode (LED) light source.

In one embodiment, the light source 2 is insertably disposed in the first groove 14 through the opening of the first groove 14, and one end of the light source 2 is detachably connected to a bottom of the first groove 14. Specifically, one end of the light source 2 adjacent to the light guide plate 4 is insertably disposed in the first groove 14 through the opening of the first groove 14, and another end of the light source 2 far away from the light guide plate 4 is detachably connected to the bottom of the first groove 14. In other words, the light source 2 can be assembled or detached through the opening of the first groove 14. For example, the light source can be fixed on the bottom of the first groove 14 by a second fixing tap. Specifically, a second fixing tap 16 is disposed on the bottom of the first groove 14, and the second fixing tap 16 is a double-sided tape. The second fixing tap 16 has two adhesive surfaces adhering to an end surface of the light source 2 and the bottom of the first groove 14, respectively. Two sides of the second fixing tap 16 are both adhesive surfaces. One of the adhesive surfaces of the second fixing tap 16 is adhesively fixed on the bottom of the first groove 14, and the other adhesive surface of the second fixing tap 16 is adhesively fixed on a side of the light source 2 far away from the light guide plate, thereby to adhesively fix the light source 2 in the first groove 14. It should be noted that the light source 2 may be detachably connected to the bottom of the first groove 14 by other ways, and thus is not limited thereto.

Furthermore, the first groove 14 can match a size and a shape of the light source 2. That is, the first groove 14 can just accommodate the light source 2. A length of the light source 2 in a direction perpendicular to the bending portion 12 is equal to a depth of the first groove 14. A side of the light source 2 adjacent to the accommodation groove 13 is flush with the inner side of the bending portion 12. The light source 2 may have a volume less than that of the first groove 14. That is, a length of the light source 2 in a direction perpendicular to the bending portion 12 is equal to a depth of the first groove 14. A side of the light source 2 adjacent to the accommodation groove 13 does not protrude from an inner side of the bending portion 12, so that the light source 2 can be protected by the first groove 14.

In this embodiment, the first groove 14 is exposed on the inner side of the bending portion 12, and the light source 2 is fixedly disposed in the first groove 14. That is, the light source 2 is disposed inside the bending portion 12 without taking up a space of the accommodation groove 13, thereby to reduce a frame size of a display device at a side of the light source in a condition that a light mixing distance in the backlight module is constant.

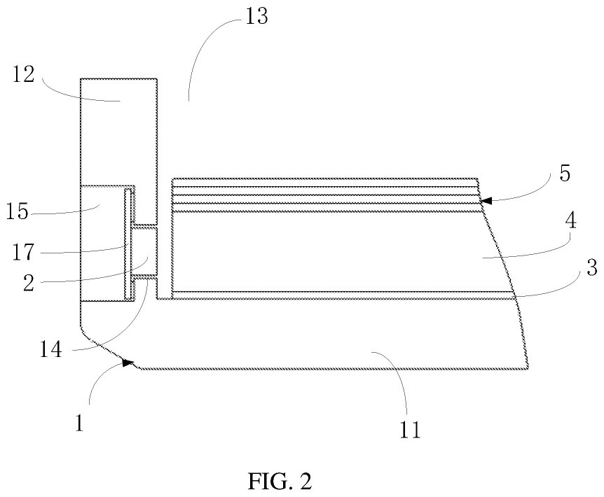

In addition, as shown in FIG. 2, a second groove 15 is disposed on an outer side of the bending portion 12 facing the first groove 14 and is exposed outside, wherein the outer side of the bending portion 12 is a surface of the bending portion 12 far away from the accommodation groove 13, and the second groove 15 is exposed in a direction away from the accommodation groove 13. The first groove 14 is corresponding to a location of the second groove 15, and the first groove 14 and the second groove 15 communicate with each other. Specifically, the first groove 14 and the second groove 15 may be in direct communication, that is, a groove bottom of the first groove 14 and a groove bottom of the second groove 15 are on the same plane. Furthermore, the first groove 14 and the second groove 15 may also communicate with each other through a through hole, that is, the through hole is formed between the groove bottom of the first groove 14 and the groove bottom of the second groove 15.

An adjoining area of where the first groove 14 communicates with the second groove 15 is greater than or equal to a cross-sectional area of the light source 2 in a direction parallel with the bending portion 12. The adjoining area is a cross-sectional area of a juncture of the first groove 14 and the second groove 15. The light source 2 is corresponding to a location of the juncture in the first groove 14.

Specifically, the second groove 15 has a bottom area greater than that of the first groove 14, wherein the entire bottom of the first groove 14 communicates with the second grove 15. A part of the bottom of the second groove 15 corresponding to the first groove 14 is in contact with first groove 14, and a remaining part of the bottom of the second groove 15 is not in contact with the first groove 14.

In one embodiment, one end of the light source 2 is insertably disposed in the first groove 14 through the second groove 15, and another end of the light source 2 is detachably connected to a bottom of the second groove 15. Specifically, one end of the light source 2 adjacent to the light guide plate 4 is disposed in the first groove 14, and one end of the light source 2 far away from the light guide plate 4 is detachably to the bottom of the second groove 15. That is, the light source 2 may be assembled in or detached from the first groove 14 through the second groove 15. For example, the light source 2 can be connected to the remaining part of the bottom of the second groove 15 by a first fixing tape. Specifically, a first fixing tape 17 is disposed on the bottom of the second groove 15, wherein the first fixing tape 17 is a single-sided tape. The first fixing tap 17 has an adhesive surface disposed facing the first groove 14 and adhering to both the bottom of the second groove 15 and the another end of the light source 2. The first groove 14 communicates with the second groove 15, and a location of the light source 2 in the first groove 14 is corresponding to a juncture of the first groove 14 and the second groove 15. Therefore, the light source 2 is exposed to the bottom of the second groove 15. The first fixing tape 17 adheres to the remaining part of the bottom of the second groove 15 and the exposed light source 2, so that the light source 2 can be adhesively fixed in the first groove 14.

When replacing the light source 2, the first fixing tap 17 is detached from the remaining part of the bottom of the second groove 15 through the second groove 15 so that the light source 2 can be taken out. In this manner, a new light source 2 is first provided with the first fixing tap 17, and then the new light source 2 with the first fixing tap 17 is insertably assembled in the first groove 14 through the second groove 15, wherein the first fixing tap 17 adheres to the remaining part of the bottom of the second groove 15, thereby to finalize the replacement of the light source 2. It should be noted that the light source 2 can also be detachably connected to the bottom of the second groove 15 by other means, which is not specifically limited herein.

Since the adjoining area of where the first groove 14 communicates with the second groove 15 in this embodiment is greater than or equal to a cross-sectional area of the light source in a direction parallel with the bending portion 12, the replacement of the light source 2 can be carried out by directly taking out the light source through the second groove 15 without disassembling the backlight module, thereby to facilitate a convenient replacement for users, and to improve replacement efficiency.

Furthermore, as shown in FIG. 1 or FIG. 2, the backlight module further includes a reflective sheet 3 and an optical film 5 sequentially disposed on the backplate 11 in the accommodation groove 13. Specifically, the reflective sheet 3, the light guide plate 4, and the optical film 5 are all disposed in the accommodation groove 13, wherein the reflective sheet 3 is disposed on the backplate 11, the light guide plate 4 is disposed on the reflective sheet 3, and the optical film 5 is disposed on the light guide plate 4, so that the reflective sheet 3, the light guide plate 4, and the optical film 5 in the accommodation groove 13 can be protected by the bracket 1. Furthermore, the light source 2 is corresponding to a location of the light guide plate 4, that is, the first groove 14 of the bending portion 12 is corresponding to a location of the light guide plate 4, wherein the light source 2 disposed in the first groove 14 can reduce a distance between the bending portion 12 and the light guide plate 4, thereby to reduce a frame size of a display device at a side of the light source in a condition that a light mixing distance in the backlight module is constant.

As described above, based on the backlight module of the embodiment, the first groove is disposed on the inner side of the bending portion facing and exposed to the light guide plate, and the light source is disposed in the first groove without the need of reserving an extra space at the inner side of the bending portion, thereby to reduce a frame size of a display device at a side of the light source in a condition that a light mixing distance in the backlight module is constant. The second groove is disposed on the outer side of the bending portion exposing outside and communicating with the first groove, wherein an adjoining area of the first and second grooves is greater than or equal to a cross-sectional area of the light source in a direction parallel with the bending portion, so that the light source can be taken out directly from the second groove to be replaced, without disassembling the backlight module, thereby to improve replacement efficiency and to enhance market competitiveness of products.

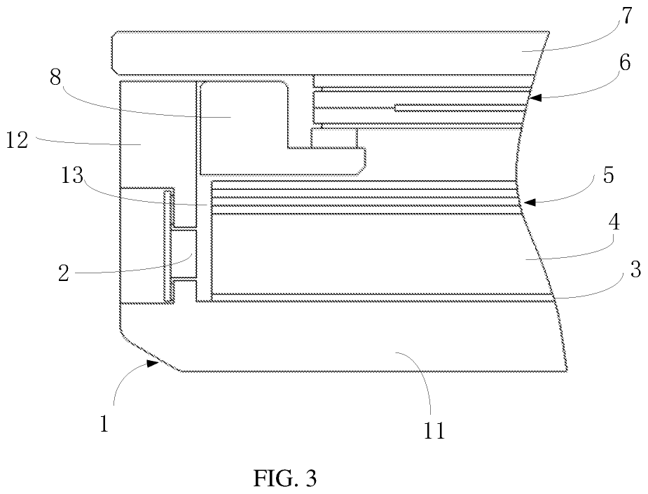

Please refer to FIG. 3 showing a schematic structural view of a display device of an embodiment of the present invention.

As shown in FIG. 3, the display device of the embodiment of the present invention includes a backlight module and a display panel 6, wherein the backlight module is embodied as the backlight module as described in the above-mentioned embodiments, and details are not described herein again. The light guide plate 4 and the display panel 6 are sequentially disposed in the accommodation groove 13 of the backlight module. Specifically, the display panel 6 is disposed on the optical film 5, and a surface of a side of the display panel 6 far away from of the backplate 11 is flush with a surface of a side of the bending portion 12 far away from the backplate 11, so that the display panel 6 can be protected by the bracket 1.

Furthermore, the display device further includes a cover plate 7 and a middle frame 8. The middle frame 8 is disposed in the accommodation groove 13 and is connected to the inner side of the bending portion 12 for supporting the display panel 6. The light guide plate 4, the middle frame 8, and the display panel 6 are sequentially disposed on the backplate 11 in the accommodation groove 13. The cover plate 7 is disposed on a side of the bracket 1 far away from the backplate 11 and is configured to encapsulate the accommodation groove 13 in the bracket 1, and is further to protect the light guide plate 4 and the display panel 6 in the accommodation groove 13. Specifically, the cover plate 7 is disposed on both a side of the display panel 6 far away from the backplate 11 and a side of the bending portion 12 far away from the backplate 11.

As described above, based on the backlight module of the embodiment, the first groove is disposed on the inner side of the bending portion facing and exposed to the light guide plate, and the light source is disposed in the first groove without the need of reserving an extra space at the inner side of the bending portion, thereby to reduce a frame size of a display device at a side of the light source in a condition that a light mixing distance in the backlight module is constant. The second groove is disposed on the outer side of the bending portion exposing outside and communicating with the first groove, wherein an adjoining area of the first and second grooves is greater than or equal to a cross-sectional area of the light source in a direction parallel with the bending portion, so that the light source can be taken out directly from the second groove to be replaced, without disassembling the backlight module, thereby to improve replacement efficiency and to enhance market competitiveness of products.

Accordingly, although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents.

What is claimed is:

1. A backlight module, comprising a light guide plate, a light source, and a bracket;
wherein the bracket comprises a backplate and a bending portion disposed along a peripheral side of the backplate, and an accommodation groove is formed in a space between the backplate and the bending portion and is configured to place the light guide plate; and
wherein a first groove is disposed on an inner side of the bending portion facing and exposed to the light guide plate, and the light source is disposed in the first groove.

2. The backlight module of claim 1, wherein a second groove is disposed on an outer side of the bending portion facing the first groove and exposed outside, wherein the first groove and the second groove communicate with each other.

3. The backlight module of claim 2, wherein an adjoining area of where the first groove communicates with the second groove is greater than or equal to a cross-sectional area of the light source in a direction parallel with the bending portion, and the second groove has a bottom area greater than that of the first groove.

4. The backlight module of claim 2, wherein one end of the light source is insertably disposed in the first groove through the second groove, and another end of the light source is detachably connected to a bottom of the second groove.

5. The backlight module of claim 4, wherein a first fixing tape is disposed on the bottom of the second groove, wherein the first fixing tape is a single-sided tape; and
wherein the first fixing tap has an adhesive surface disposed facing the first groove and adhering to both the bottom of the second groove and the another end of the light source.

6. The backlight module of claim 1, wherein the light source is insertably disposed in the first groove through an opening of the first groove, and one end of the light source is detachably connected to a bottom of the first groove.

7. The backlight module of claim 6, wherein a second fixing tap is disposed on the bottom of the first groove, and the second fixing tap is a double-sided tape; and
wherein the second fixing tap has two adhesive surfaces adhering to an end surface of the light source and the bottom of the first groove, respectively.

8. The backlight module of claim 1, further comprising a reflective sheet and an optical film, wherein the reflective sheet, the light guide plate, and the optical film are sequentially disposed on the backplate in the accommodation groove.

9. A display device, comprising a display panel and a backlight module, wherein the backlight module comprises a light guide plate, a light source, and a bracket, wherein the bracket comprises a backplate and a bending portion disposed along a peripheral side of the backplate, and an accommodation groove is formed in a space between the backplate and the bending portion and is configured to place the light guide plate; and
wherein a first groove is disposed on an inner side of the bending portion facing and exposed to the light guide plate, and the light source is disposed in the first groove, wherein the light guide plate and the display panel are sequentially disposed on the backplate in the accommodation groove.

10. The display device of claim 9, wherein a second groove is disposed on an outer side of the bending portion facing the first groove and is exposed outside, wherein the first groove and the second groove communicate with each other.

11. The display device of claim 10, wherein an adjoining area of where the first groove communicates with the second groove is greater than or equal to a cross-sectional area of the light source in a direction parallel with the bending portion, and the second groove has a bottom area greater than that of the first groove.

12. The display device of claim 10, wherein one end of the light source is insertably disposed in the first groove through the second groove, and another end of the light source is detachably connected to a bottom of the second groove.

13. The display device of claim 12, wherein a first fixing tape is disposed on the bottom of the second groove, wherein the first fixing tape is a single-sided tape; and
wherein the first fixing tap has an adhesive surface disposed facing the first groove and adhering to both the bottom of the second groove and the another end of the light source.

14. The display device of claim 9, wherein the light source is insertably disposed in the first groove through an opening of the first groove, and one end of the light source is detachably connected to a bottom of the first groove.

15. The display device of claim 14, wherein a second fixing tap is disposed on the bottom of the first groove, and the second fixing tap is a double-sided tape; and
wherein the second fixing tap has two adhesive surfaces adhering to an end surface of the light source and the bottom of the first groove, respectively.

16. The display device of claim 9, wherein the backlight module further comprises a reflective sheet and an optical film, wherein the reflective sheet, the light guide plate, and the optical film are sequentially disposed on the backplate in the accommodation groove.

17. The display device of claim 9, further comprising a cover plate and a middle frame configure for supporting the display panel;
wherein the middle frame is disposed in the accommodation groove and is connected to the inner side of the bending portion; and wherein the light guide plate, the middle frame, and the display panel are sequentially disposed on the backplate in the accommodation groove, and the cover plate is disposed on a side of the bracket far away from the backplate.
